(19) United States
(12) Patent Application Publication
(10) Pub. No.: US 2023/0359882 A1
(43) Pub. Date: Nov. 9, 2023

(54) TRAINING A NEURAL NETWORK TO ACHIEVE AVERAGE CALIBRATION

(71) Applicant: International Business Machines Corporation, Armonk, NY (US)

(72) Inventors: Hiroki Yanagisawa, Kawasaki (JP); Toshiya Iwamori, Tokyo (JP); Akira Koseki, Kanagawa-ken (JP); Michiharu Kudo, Kamakura-shi (JP)

(21) Appl. No.: 17/738,268

(22) Filed: May 6, 2022

(51) Int. Cl. G06N 3/08; G06K 9/62

(52) U.S. Cl. CPC G06N 3/08; G06K 9/6228; G06K 9/6298

(57) ABSTRACT

A method, which trains a neural network to perform an analysis that satisfies average calibration, includes a processor manipulating a data set that includes an outcomes vector and a set of feature vectors, each of which corresponds to one of the outcomes in the outcomes vector. The processor repeatedly: selects a subset of the set of feature vectors; generates a distribution vector for a subset of the outcomes vector that corresponds to the subset of the set of feature vectors; produces a prediction vector by running the neural network on the subset of the set of feature vectors; calculates a Bregman divergence between the distribution vector and a scoring distribution vector of the prediction vector; and updates weights of the neural network based on the Bregman divergence.

### BACKGROUND

The present invention relates to the electrical, electronic, and computer arts, and more specifically, to improvements in machine learning.

The average calibration, and its stronger variant, group calibration, are important in predictive analysis. Average calibration measures how well a model's averaged predicted probability approaches the empirical probability of an entire training data set. Simple prediction models (e.g., linear regression) are designed for, and usually achieve, average calibration within a satisfactory threshold. Some more complex prediction models (e.g., neural networks) are known to fall short of the simple models on the average calibration metric.

Group calibration measures how well a model's predicted probability approaches the empirical probability for a subset or a plurality of subsets of the training data set. Group calibration equals average calibration when the subset is the entire set.

### SUMMARY po Principles of the invention provide techniques for training a neural network to achieve average calibration.

In one aspect, an exemplary method for improving the performance of a machine learning system trains a neural network of the machine learning system to perform an analysis that satisfies average calibration. The method includes obtaining, using at least one hardware processor, a data set D that includes an outcomes vector and a set of feature vectors, each of which corresponds to one of the outcomes in the outcomes vector. The processor repeatedly: selects a subset of the set of feature vectors; generates a distribution vector for a subset of the outcomes vector that corresponds to the subset of the set of feature vectors; produces a prediction vector by running the neural network on the subset of the set of feature vectors; calculates a Bregman divergence between the distribution vector and a scoring distribution vector of the prediction vector; and updates weights of the neural network based on the Bregman divergence.

In another aspect, a computer-implemented method for improving the performance of a machine learning system trains a neural network to perform an analysis that satisfies average calibration. The method includes: selecting, using at least one hardware processor, a subset of a set of feature vectors and a subset of an outcomes vector, wherein each outcome in the subset of the outcomes vector corresponds to one of the feature vectors in the subset of the set of feature vectors; splitting, using the at least one hardware processor, the subset of the outcomes vector into a number of buckets; initializing a distribution vector that has a number of dimensions corresponding to the number of buckets plus an extra dimension; assigning to each dimension of the distribution vector, using the at least one hardware processor, a value equal to a number of data points in a corresponding bucket; and assigning to the extra dimension of the distribution vector, using the at least one hardware processor, a value equal to a total population of the subset of the set of feature vectors minus a total number of data points in the subset of the outcomes vector.

In another aspect, an apparatus includes a memory that embodies computer executable instructions; and at least one processor, coupled to the memory, and configured by the computer executable instructions to embody a neural network and to facilitate: obtaining an outcomes vector and a feature vector that corresponds to the outcomes vector; and repeatedly: selecting a subset of the set of feature vectors; generating a distribution vector for a subset of the outcomes vector that corresponds to the subset of the set of feature vectors; producing a prediction vector by running a neural network on the subset of the set of feature vectors; calculating a Bregman divergence between a scoring distribution vector of the prediction vector and the distribution vector; and updating weights of the neural network based on the Bregman divergence.

One or more embodiments of the invention or elements thereof can be implemented in the form of a computer program product including a computer readable storage medium with computer usable program code for facilitating the method steps indicated. Furthermore, one or more embodiments of the invention or elements thereof can be implemented in the form of a system (or apparatus) including a memory that embodies computer executable instructions, and at least one processor that is coupled to the memory and operative by the instructions to facilitate exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a tangible computer readable storage medium (or multiple such media) and implemented on a hardware processor, or (iii) a combination of (i) and (ii); any of (i)-(iii) implement the specific techniques set forth herein.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

In view of the foregoing, techniques of the present invention can provide substantial beneficial technical effects. For example, one or more embodiments provide one or more of:
A trained neural network that can recover a true probability distribution, i.e. satisfy average calibration.
An algorithm for training a neural network on a truncated output data set.
A metric to measure the calibration performance of a prediction model for survival analysis.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 depicts a hybrid data flow diagram and method flow chart for training a neural network to achieve average calibration on a data set that is truncated, according to exemplary embodiments.

FIG. 2 depicts a maintenance planning method for deploying a neural network, which has been trained according to exemplary embodiments.

FIG. 3 depicts a medical treatment method for deploying a neural network, which has been trained according to exemplary embodiments.

FIG. 4 depicts an exemplary computer apparatus that is configured to implement the method shown in FIG. 1, according to exemplary embodiments.

### DETAILED DESCRIPTION

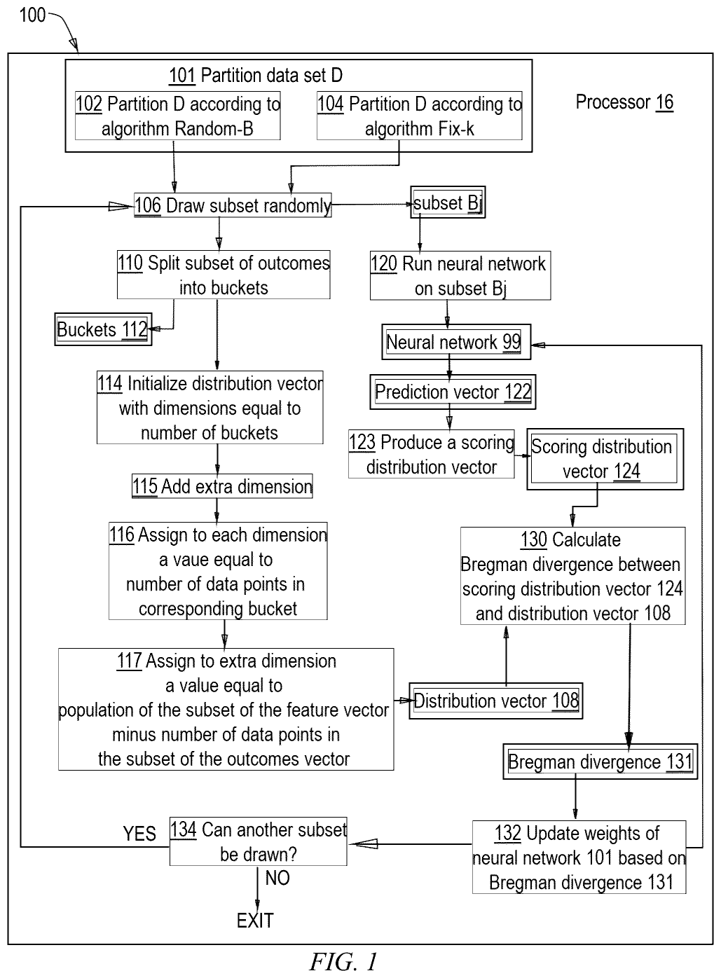

FIG. 1 is a hybrid data flow diagram and flow chart that depicts a 100 that acts on a neural network 99 to train the network to achieve average calibration on a data set that is truncated, e.g., survival data. The method 100 includes some steps that are not needed for data that is not truncated (a complete data set). Accordingly, if working with a complete data set, those steps can be omitted. In the diagram of FIG. 1, method steps are indicated by a single-line rectangle while data structures and blocks are indicated by a double-line rectangle.

As mentioned, neural networks generally have trouble achieving average calibration. Embodiments of the invention provide a new neural network training method that enables the neural network to achieve the average calibration by focusing on the group calibration for randomly sampled subsets of a data set. Some aspects of the invention generally include an improved algorithm for scoring multiple samples, and, more specifically for training on truncated outcomes vectors, an algorithm for generating a distribution of the truncated data in the computation of the scoring rule. These elements can be combined with any neural network model to improve calibration.

Particular embodiments of the invention are especially applicable to survival analysis. Survival analysis, which is also known as time-to-event analysis, is the problem to predict the time of an event's occurrence. Survival analysis has important applications in healthcare as well as various other fields such as credit scoring and equipment maintenance planning. The predicted event typically is undesirable (e.g., in equipment maintenance planning, a component failure). The time between a well-defined starting point and the predicted occurrence of the event is called the survival time or event time.

Data sets in survival analysis are unusual, in that a set of input data (e.g., risk factors for occurrence of the event) almost always has a greater population than a corresponding set of outcomes data (i.e., recorded times of occurrences of the event). This is because in any setting, longitudinal surveys seldom are conducted for long enough to capture occurrences of the event for all members of the survey population. This means that events of interest might not be observed for a number of survey participants, due to either a limited observation time window or missing traces caused by other irrelevant events. Generally, survival data is right-truncated, i.e., the event does not occur for some participants during the survey that generates the training data. The exact event time of a right-truncated data point is unknown; what is known is that the event had not happened for that participant during the survey. In this disclosure, the time between a well-defined starting point and the observation time of the last data point for which the event occurred is called the truncating time.

A classic method for survival analysis is the Kaplan-Meier estimator. It is a non-parametric method to estimate the distribution of the survival times as a survival function S(t), where the value S(t) represents the survival rate at time t (i.e., the ratio of the patients who survived at time t). The empirical survival rate S(t) at t=∞ must be zero, but due to truncation, the survival function S(t) can be estimated only for t∈[0, t*] with some t*<∞.

Many applications seek an estimate of the survival function S(t|x) for each individual participant x. In these applications, neural networks typically have been trained to minimize errors in prediction of S(t|x) on a single-participant basis. Surprisingly, neural networks trained in this manner typically do not achieve average calibration. That is, although the trained neural networks approximate the empirical event times for most of the participants in the training data set, they do not approximate the Kaplan-Meier survival function S(t).

Failure to achieve average calibration is problematic because it implies that the trained neural networks do not generalize sufficiently to produce reliable predictions for novel data. Indeed, it can be expected that predictions obtained from a model that does not achieve the average calibration are pessimistic or optimistic as a whole compared with the unknown actuals. In many settings, whether in prescribing medical treatments or in scheduling preventative maintenance for machinery, decisions made based on a model that does not reliably predict the actuals are unlikely to be optimal.

Denote the input of survival analysis as a data set D={(xᵢ, zᵢ, δᵢ)}₍ᵢ₌₁₎ⁿ of size n, where xᵢ is a feature vector in feature space X, zᵢ∈T is an outcomes vector of last observation times (i.e., each zᵢ records an event time t1 or the truncating time cᵢ), and δᵢ∈{0, 1} indicates if the i-th data point is truncated or not. If δᵢ=1, the i-th data point is untruncated and zᵢ is equal to the event time tᵢ. Otherwise (i.e., δᵢ=0), the i-th data point is truncated and zᵢ is equal to the truncating time cᵢ. This means that the exact event time is not known and instead it is known only that the event time is larger than the truncating time (i.e., tᵢ>zᵢ).

Referring to the method 100 as shown in FIG. 1, first, in step 101, partition a plurality of subsets of the data set D. Two different algorithms can be used to partition subsets of D.

Algorithm Random-B. This algorithm aims at the group calibration for any subset B of D. Therefore, each subset B is drawn uniformly randomly from 2ⁿ subsets of D, where n equals the population of D. Thus, in one or more embodiments, at 102, a processor 16 partitions D into a disjoint collection of subsets B^{o}={Bⱼ}₍ⱼ₌₁₎^{(J)}. The size of each subset Bⱼ is determined by using the binomial distribution with parameters n equal to the population of D and p=0.5.

Algorithm Fix-k. Since the sizes of the subsets in B generated by Algorithm Random-B are almost equal to n/2, algorithm Fix-k can be used instead to generate smaller subsets. In algorithm Fix-k, at 104, the processor 16 disjointly partitions D into a collection of random subsets B^{o}={Bⱼ}₍ⱼ₌₁₎^{(J)} such that the population of each Bⱼ=k, where k is a parameter to specify the size of a subset.

Next, at 106, the processor 16 draws a subset B randomly from D{Bₖ}₍ₖ₌₁₎^{(j-1)}. The subset Bⱼ will include a subset of the set of features vectors and a corresponding subset of the outcomes vector. The subset of the outcomes vector may be smaller than the subset of the features vectors, i.e. there may be some features vectors that do not have corresponding outcomes due to no observed data point.

Then, generate a distribution vector 108 for the subset Bⱼ. To generate the distribution vector 108, at 110, the processor 16 splits a subset of the outcomes vector zᵢ into a number of buckets 112. At 114, the processor 16 initializes the distribution vector 108 with a number of dimensions that is equal to the number of buckets 108. In some cases, for example, when a data set is truncated by the absence of observed event times for some members of the data set population, then not every feature vector will have a corresponding observed outcome. In other words, in some cases, the number of data points in the subset of the outcomes vector is smaller than the population of the corresponding subset of the set of feature vectors xᵢ. This is referred to as the data set being truncated. When the method 100 is implemented on a data set that is truncated, then at 115, the processor 16 adds an extra dimension to the distribution vector. At 116, the processor 16 assigns to each dimension of the distribution vector 108 a value equal to the number of data points in a corresponding bucket 112. If the distribution vector was made with an extra dimension, i.e. if the data set is truncated, then at 117, the processor 16 assigns to the extra dimension of the distribution vector a value equal to the population of the subset of the set of feature vectors minus the number of data points in the subset of the outcomes vector. Thus, steps 115 and 117 adjust the distribution vector to handle the situation where the data set is truncated and the subset of the outcomes vector is smaller than the corresponding subset of features vectors.

The skilled worker will appreciate that if the data set D is not truncated, i.e. there are as many points in the outcomes vector as there are features vectors in the subset of features vectors, then an extra dimension is not needed when generating the distribution vector. Therefore, steps 115 and 117 can be omitted if using a complete data set to train the neural network. A decision block to check for truncation and to skip steps 115 and 117 in the absence of truncation is omitted from the diagram to avoid clutter.

In one or more embodiments, use a Kaplan-Meier estimator to assign values to each dimension of the vector that corresponds to a bucket. In one or more embodiments, use a Nelson-Aalen estimator to assign values to each dimension of the vector that corresponds to a bucket.

At 120, the processor 16 produces a prediction vector 122 by running the neural network 99 on the subset Bⱼ of the feature vector. Then at 123, the processor 16 produces a scoring distribution vector 124 for the prediction vector 122, following the same procedure discussed above for generating the distribution vector 108 for the outcomes vector of the subset Bⱼ.

At 130, the processor 16 calculates a Bregman divergence 131 between the scoring distribution vector 122 and the distribution vector 108.

At 132, the processor 16 updates weights of the neural network based on the Bregman divergence, i.e. using the Bregman divergence as the loss function. A loss function l(f(x), y) is typically computed during the training of a neural network, where f(x) is the output of a neural network for input x and y is the target value. The loss function is used to measure the distance between f(x) and y (i.e., smaller distance is better). Any neural network algorithm has its own algorithm to update the weights of the neural network based on l(f(x), y), and users of the neural network typically do not care what algorithm is used for updating the weights. Some exemplary algorithms for updating weights, well known to the skilled worker, include Adam, RMSprop, AdaGrad, and SGD.

In one or more embodiments, use a squared loss as the Bregman divergence. In one or more embodiments, use a Kullback-Leibler divergence as the Bregman divergence.

At 134, the processor 16 checks whether a new subset can be drawn. If YES, repeat from step 106. If NO, exit.

In one or more embodiments, the neural network 99 is a two-layer perceptron with 32 outputs and a single hidden layer containing 128 neurons. The activation function after the hidden layer is the rectified linear unit (ReLU) type, and the activation function at the output node is softmax.

Calibration performance of the trained neural network 99 can be measured using an expected calibration score, which is defined as

$$γ ( B , w ) = {\sum }_{( b ∈ B )} ( {w}_{b} , {γ}_{b} ) ,$$

where

γ_{b}=E_{(BD}_{ₜₑₛₜ}_{:vBvb)}[d_{G}(f_{T}, p_{X})]

Dₜₑₛₜ is the test dataset, B˜Dₜₑₛₜ means that B is a random subset drawn from Dₜₑₛₜ, β is a set of integers, and

w_{b}∈R_{≥0}

is a weight parameter that is used to show preference for different connections in the neural network. A large w_{b} means that the corresponding connection term (γ_{b}) is preferred. If there is no preference, set w_{b}=1 for all b. For example, β={1,2,2², . . . , 2^{log}^{₂}ⁿ^{ₜₑₛₜ}, nₜₑₛₜ} and w_{b}=1 for all b∈β. The metric γ_{b} measures the expected calibration score for a randomly sampled subset B of size b. For a prediction model such that γₙ test is close to zero, where nₜₑₛₜ is the size of the test dataset, the model approaches the average calibration. If b is a large number (e.g., b>nₜₑₛₜ/3), γ_{b} should be close to γᵢₙₜₑₛₜ.In contrast, γ_{b} with a small b can be seen as a metric for discrimination performance.

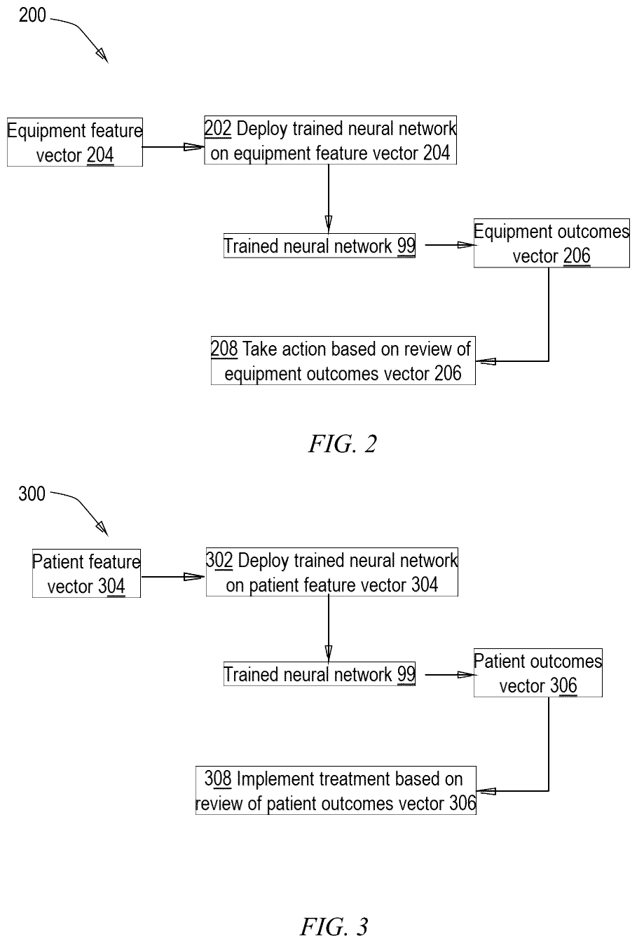

One or more embodiments include a maintenance planning method 200, as shown in FIG. 2, in which at 202 the trained neural network 99 is deployed on an equipment feature vector 204 to produce an equipment outcomes vector 206 that includes a plurality of survival times, e.g., predicted times of mechanical or electronic component failures. At 208, based on review of the equipment outcomes vector 206, action is directed; e.g., performing preventative maintenance on equipment described by the equipment feature vector 204, before a component failure time as predicted by the equipment outcomes vector 206. This can be especially helpful in instances where failure would have serios consequences; for example, flight- or mission-critical hardware for aircraft systems.

One or more embodiments include a medical treatment method 300, as shown in FIG. 3, in which at 302 the trained neural network 99 is deployed on a patient feature vector 304, which includes a medical diagnosis and a plurality of potential treatments corresponding to a patient. Deploying the trained neural network 99 on the patient feature vector 304 produces a potential outcomes vector 306, in which each predicted survival time corresponds to one of the potential treatments. Then at 308, implement, for the patient, one of the potential treatments that has the latest predicted survival time. For example, administer medication to the patient.

Given the discussion thus far, and with reference to the accompanying drawing views, it will be appreciated that, in general terms, an exemplary method 100, which improves the performance of a machine learning system by training a neural network 99 of the machine learning system to perform an analysis that satisfies average calibration, includes at least one hardware processor 16 obtaining a data set D that includes an outcomes vector and a set of feature vectors, each of which corresponds to one of the outcomes in the outcomes vector. The processor 16 repeatedly: at 106, selects a subset of the set of feature vectors; at 110, 114, and 116, generates a distribution vector 108 for a subset of the outcomes vector that corresponds to the subset of the set of feature vectors; at 120, produces a prediction vector 122 by running the neural network on the subset of the set of feature vectors; at 130, calculates a Bregman divergence 131 between the distribution vector and a scoring distribution vector 124 of the prediction vector 122; and, at 132, updates weights of the neural network based on the Bregman divergence.

In one or more embodiments, generating the distribution vector includes, at 110, splitting the subset of the outcomes vector into a number of buckets; at 114, initializing the distribution vector with a number of dimensions corresponding to the number of buckets plus an extra dimension; and, at 117, assigning, to the extra dimension of the distribution vector, a value equal to a total population of the subset of the set of feature vectors minus a total number of data points in the subset of the outcomes vector. In one or more embodiments, generating the distribution vector also includes using a Kaplan-Meier estimator to assign a value to each dimension of the distribution vector that corresponds to a bucket.

In one or more embodiments, the method 100 also includes at 202, the at least one hardware processor 16 producing an equipment outcomes vector 206 by deploying the trained neural network on an equipment feature vector 204; and, at 208, performing preventative maintenance on equipment, based on review of the equipment outcomes vector.

In one or more embodiments, the method 100 also includes using a squared loss as the Bregman divergence.

In one or more embodiments, the method 100 also includes using a Kullback-Leibler divergence as the Bregman divergence.

In one or more embodiments, selecting the subset of the set of feature vectors comprises drawing the subset from 2ⁿ subsets of D, wherein a size of each subset is determined by using a binomial distribution with parameters n and p, wherein n is equal to the population of D and p is equal to 0.5.

In one or more embodiments, selecting the subset of the set of feature vectors comprises drawing the subset from a collection of random subsets of D, wherein each of the random subsets is of a same size k.

In another aspect, at least one hardware processor 16 implements a method 100, which includes: at 106, selecting a subset of a set of feature vectors and a subset of an outcomes vector, wherein each outcome in the subset of the outcomes vector corresponds to one of the feature vectors in the subset of the set of feature vectors; at 110, splitting the subset of the outcomes vector into a number of buckets; at 114 and 115, initializing a distribution vector that has a number of dimensions corresponding to the number of buckets plus an extra dimension; at 116, assigning to each dimension of the distribution vector a value equal to a number of data points in a corresponding bucket; and at 117, assigning to the extra dimension of the distribution vector a value equal to a total population of the subset of the set of feature vectors minus a total number of data points in the subset of the outcomes vector.

In one or more embodiments, the method 100 also includes: at 120, producing a prediction vector 122 by running the neural network 99 on the subset of the set of feature vectors; at 130, calculating a Bregman divergence 131 between the distribution vector and a scoring distribution vector 124 of the prediction vector; at 132, updating weights of the neural network 99 based on the Bregman divergence; at 134, selecting different subsets of the set of features vector and the outcomes vector; and repeating the method for the different subsets.

In one or more embodiments, the method 100 includes using a squared loss as the Bregman divergence.

In one or more embodiments, the method 100 includes using a Kullback-Leibler divergence as the Bregman divergence.

In one or more embodiments, the method 100 includes using a Kaplan-Meier estimator to assign values to each dimension of the distribution vector that corresponds to a bucket.

In one or more embodiments, the method 100 includes using a Nelson-Aalen estimator to assign values to each dimension of the distribution vector that corresponds to a bucket.

In one or more embodiments, selecting the subset of the set of feature vectors includes drawing the subset from 2ⁿ subsets of the feature vector, wherein a size of each subset is determined by using a binomial distribution with parameters n and p, wherein n is equal to a population of the feature vector and p is equal to 0.5.

In one or more embodiments, selecting the subset of the set of feature vectors includes drawing the subset from a collection of random subsets of the feature vector, wherein each of the random subsets is of a same size k and the number of random subsets is approximately equal to the population of the feature vector divided by k.

Another aspect provides an apparatus 10 for improving the performance of a computerized machine learning system by training a neural network of the computerized machine learning system to perform an analysis that satisfies average calibration. The apparatus 10 includes a memory 28 that embodies computer executable instructions; and at least one processor 16, coupled to the memory, and configured by the computer executable instructions to embody a neural network and to facilitate: obtaining an outcomes vector and a feature vector that corresponds to the outcomes vector; and repeatedly: at 106, selecting a subset of the set of feature vectors; at 110, 114, 116, generating a distribution vector for a subset of the outcomes vector that corresponds to the subset of the set of feature vectors; at 120, producing a prediction vector 122 by running a neural network 99 on the subset of the set of feature vectors; calculating a Bregman divergence between a scoring distribution vector of the prediction vector and the distribution vector; and at 132, updating weights of the neural network based on the Bregman divergence.

In one or more embodiments, the outcomes vector has fewer data points than a population of the feature vector, and generating the distribution vector includes, at 110, splitting the subset of the outcomes vector into a number of buckets, each bucket containing at least one data point; at 114, initializing the distribution vector with a number of dimensions corresponding to the number of buckets plus an extra dimension; and, at 117, assigning, to the extra dimension of the distribution vector, a value equal to a total population of the subset of the set of feature vectors minus a total number of data points in the subset of the outcomes vector.

In one or more embodiments, the at least one processor 16 is further configured by the computer executable instructions to facilitate using a Kullback-Leibler divergence as the Bregman divergence.

In one or more embodiments, the at least one processor 16 is further configured by the computer executable instructions to facilitate receiving a novel feature vector; and, at 202 or 302, producing a novel outcomes vector by running the neural network on the novel feature vector.

Aspects of the invention can be implemented using a conventional, Von Neumann, processor and memory architecture, as discussed below. On the other hand, some embodiments can be implemented in alternative processor architectures, such as non-Von Neumann architectures with computation in memory.

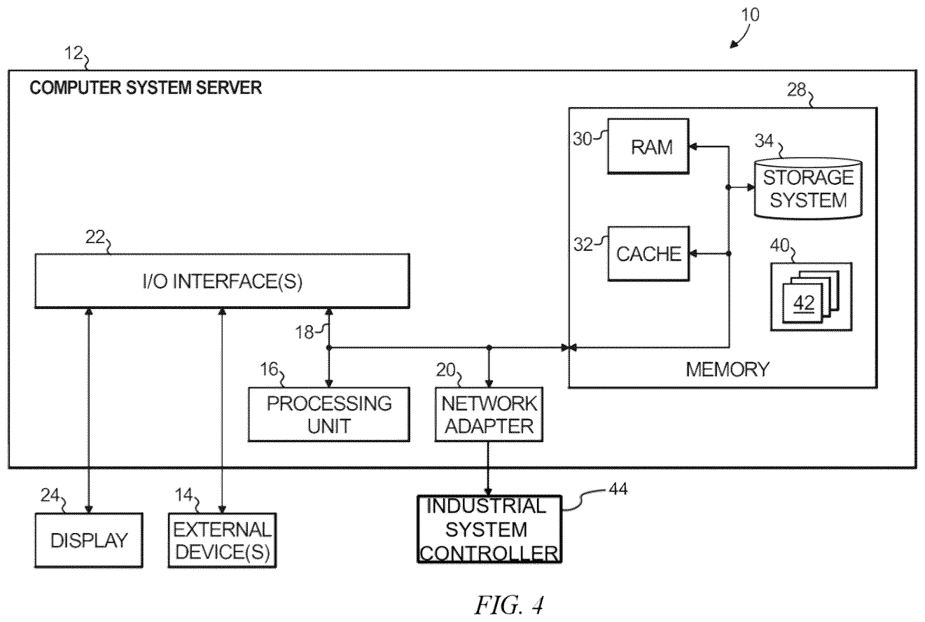

One or more embodiments of the invention, or elements thereof, can be implemented in the form of an apparatus including a memory and at least one processor that is coupled to the memory and operative to facilitate exemplary method steps, or in the form of a non-transitory computer readable medium embodying computer executable instructions which when executed by a computer cause the computer to facilitate exemplary method steps. FIG. 4 depicts a computer system that may be useful in implementing one or more aspects and/or elements of the invention, also representative of a cloud computing node according to an embodiment of the present invention. Referring now to FIG. 4, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 4, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or via network adapter 20 (e.g., network card, modem, etc.) with one or more other computing devices 44 (e.g., an industrial system controller). Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 4, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 4) running a server program. It will be understood that such a physical server may or may not include a display and keyboard.

One or more embodiments can be at least partially implemented in the context of a cloud or virtual machine environment, although this is exemplary and non-limiting.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

### Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for improving the performance of a machine learning system by training a neural network to perform an analysis that satisfies average calibration, the method comprising:
obtaining, using at least one hardware processor, an outcomes vector and a set of feature vectors, each of which corresponds to one of the outcomes in the outcomes vector; and
repeatedly, using at least one hardware processor:
selecting a subset of the set of feature vectors;
generating a distribution vector for a subset of the outcomes vector that corresponds to the subset of the set of feature vectors;
producing a prediction vector by running the neural network on the subset of the set of feature vectors;
calculating a Bregman divergence between the distribution vector and a scoring distribution vector of the prediction vector; and
updating weights of the neural network based on the Bregman divergence.

2. The method of claim 1, wherein generating the distribution vector comprises:
splitting the subset of the outcomes vector into a number of buckets;
initializing the distribution vector with a number of dimensions corresponding to the number of buckets plus an extra dimension; and
assigning, to the extra dimension of the distribution vector, a value equal to a total population of the subset of the set of feature vectors minus a total number of data points in the subset of the outcomes vector.

3. The method of claim 2, wherein generating the distribution vector further comprises: using a Kaplan-Meier estimator to assign a value to each dimension of the distribution vector that corresponds to a bucket.

4. The method of claim 1, further comprising:
the at least one hardware processor producing an equipment outcomes vector by deploying the trained neural network on an equipment feature vector; and
performing preventative maintenance on equipment, based on review of the equipment outcomes vector.

5. The method of claim 1, further comprising: using a squared loss as the Bregman divergence.

6. The method of claim 1, further comprising: using a Kullback-Leibler divergence as the Bregman divergence.

7. The method of claim 1, wherein selecting the subset of the set of feature vectors comprises drawing the subset from 2ⁿ subsets of D, wherein a size of each subset is determined by using a binomial distribution with parameters n and p, wherein n is equal to the population of D and p is equal to 0.5.

8. The method of claim 1, wherein selecting the subset of the set of feature vectors comprises drawing the subset from a collection of random subsets of D, wherein each of the random subsets is of a same size k.

9. A computer-implemented method for improving the performance of a machine learning system by training a neural network to perform an analysis that satisfies average calibration, the method comprising:
selecting, using at least one hardware processor, a subset of a set of feature vectors;
selecting, using the at least one hardware processor, a subset of an outcomes vector, wherein each outcome in the subset of the outcomes vector corresponds to one of the feature vectors in the subset of the set of feature vectors;
splitting, using the at least one hardware processor, the subset of the outcomes vector into a number of buckets;
initializing, using the at least one hardware processor, a distribution vector that has a number of dimensions corresponding to the number of buckets plus an extra dimension;
assigning to each dimension of the distribution vector, using the at least one hardware processor, a value equal to a number of data points in a corresponding bucket; and
assigning to the extra dimension of the distribution vector, using the at least one hardware processor, a value equal to a total population of the subset of the set of feature vectors minus a total number of data points in the subset of the outcomes vector.

10. The method of claim 9, further comprising:
producing, using the at least one hardware processor, a prediction vector by running a neural network on the subset of the set of feature vectors;
calculating, using the at least one hardware processor, a Bregman divergence between the distribution vector and a scoring distribution vector of the prediction vector;
updating, using the at least one hardware processor, weights of the neural network based on the Bregman divergence;
selecting, using the at least one hardware processor, a different subset of the set of features vector and the outcomes vector; and
repeating, using the at least one hardware processor, the steps of splitting the different subset, initializing a distribution vector for the different subset, assigning a value to each dimension of the distribution vector for the different subset, assigning a value to the extra dimension of the distribution vector for the different subset, producing a prediction vector, calculating a Bregman divergence, and updating weights.

11. The method of claim 10, further comprising: using a squared loss as the Bregman divergence.

12. The method of claim 10, further comprising: using a Kullback-Leibler divergence as the Bregman divergence.

13. The method of claim 9, further comprising: using a Kaplan-Meier estimator to assign values to each dimension of the distribution vector that corresponds to a bucket.

14. The method of claim 9, further comprising: using a Nelson-Aalen estimator to assign values to each dimension of the distribution vector that corresponds to a bucket.

15. The method of claim 9, wherein selecting the subset of the set of feature vectors comprises drawing the subset from 2ⁿ subsets of the feature vector, wherein a size of each subset is determined by using a binomial distribution with parameters n and p, wherein n is equal to a population of the feature vector and p is equal to 0.5.

16. The method of claim 9, wherein selecting the subset of the set of feature vectors comprises drawing the subset from a collection of random subsets of the feature vector, wherein each of the random subsets is of a same size k and the number of random subsets is approximately equal to the population of the feature vector divided by k.

17. An apparatus for improving the performance of a computerized machine learning system by training a neural network of the computerized machine learning system to perform an analysis that satisfies average calibration, the apparatus comprising:
a memory that embodies computer executable instructions; and
at least one processor, coupled to the memory, and configured by the computer executable instructions to embody a neural network and to facilitate:
obtaining an outcomes vector and a feature vector that corresponds to the outcomes vector; and
repeatedly:
selecting a subset of the set of feature vectors;
generating a distribution vector for a subset of the outcomes vector that corresponds to the subset of the set of feature vectors;
producing a prediction vector by running the neural network on the subset of the set of feature vectors;
calculating a Bregman divergence between a scoring distribution vector of the prediction vector and the distribution vector; and
updating weights of the neural network based on the Bregman divergence.

18. The apparatus of claim 17, wherein the outcomes vector has fewer data points than a population of the feature vector, and generating the distribution vector comprises:
splitting the subset of the outcomes vector into a number of buckets, wherein each bucket contains at least one data point;
initializing the distribution vector with a number of dimensions corresponding to the number of buckets plus an extra dimension; and
assigning, to the extra dimension of the distribution vector, a value equal to a total population of the subset of the set of feature vectors minus a total number of data points in the subset of the outcomes vector.

19. The apparatus of claim 17, wherein the at least one processor is further configured by the computer executable instructions to facilitate: using a Kullback-Leibler divergence as the Bregman divergence.

20. The apparatus of claim 19, wherein the at least one processor is further configured by the computer executable instructions to facilitate: receiving a novel feature vector; and producing a novel outcomes vector by running the neural network on the novel feature vector.
